(19) United States
(12) Patent Application Publication
(10) Pub. No.: US 2013/0174780 A1
(43) Pub. Date: Jul. 11, 2013

(54) DEPOSITION MASK AND DEPOSITION DEVICE USING THE SAME

(71) Applicants: Suk-Beom You, Yongin-si (KR); Joo-Hwa Lee, Yongin-si (KR); Oh-Seob Kwon, Yongin-si (KR); Seung-Jun Moon, Yongin-si (KR)

(72) Inventors: Suk-Beom You, Yongin-si (KR); Joo-Hwa Lee, Yongin-si (KR); Oh-Seob Kwon, Yongin-si (KR); Seung-Jun Moon, Yongin-si (KR)

(21) Appl. No.: 13/595,978

(22) Filed: Aug. 27, 2012

(30) Foreign Application Priority Data
Jan. 9, 2012 (KR) 10-2012-0002550

(51) Int. Cl. B05C 11/00

(52) U.S. Cl. 118/505; 118/504

(57) ABSTRACT

A deposition mask and a deposition device using the same, the deposition mask including a mask body, a plurality of slits in the mask body, and a plurality of ribs between the slits, wherein the slits include a plurality of deposition slits, and a plurality of dummy slits near the deposition slits.

### RELATED APPLICATIONS

This application claims priority to and the benefit of Korean Patent Application No. 10-2012-0002550 filed in the Korean Intellectual Property Office on Jan. 9, 2012, the entire content of which is incorporated herein by reference.

### BACKGROUND

1. Field

The described technology relates generally to a deposition mask and a deposition device using the same.

2. Description of Related Art

The light emitting diode is classified as an inorganic light emitting diode and an organic light emitting diode according to materials that are used for forming an emission layer of the light emitting diode. An organic light emitting diode is a self-emissive display element having features such as a wide viewing angle, excellent contrast, and a fast response speed, and organic light emitting diodes have been receiving attention as one of next generation display elements. Compared to the inorganic light emitting diode, the organic light emitting diode has excellent characteristics, such as luminance and response speed, and also has a characteristic of color displaying. Accordingly, the organic light emitting diode has been actively developed.

The organic light emitting diode includes a first electrode formed on a transparent insulation substrate, an organic film formed on the first electrode through a vacuous deposition method, and a second electrode formed on the organic film. The first electrode is made of a transparent conductive material, such as indium tin oxide (ITO), and is generated by a photolithography method.

However, the photolithography method is available for a manufacturing stage before the organic film is formed, and a problem may arise when using the method after the organic film is formed. That is, the organic film is very sensitive to moisture, and must be kept separate from moisture during and after its manufacturing process. Therefore, the photolithography method in which the organic film is exposed to moisture during a resist delaminating process and an etching process is inappropriate for patterning of the organic film and the second electrode layer.

To solve the above-noted problem, an organic light emitting material forming the organic film, and a material forming the second electrode, are deposited in the vacuous state by using a mask with a predetermined pattern. The second electrode can be patterned by using a cathode separator, which is a predetermined separating wall. However, it is more appropriate for a low molecular organic film from among the organic films to be patterned through the vacuous deposition method by using a deposition mask.

The method for patterning the organic film (an emission layer) by using a mask is a very important method when a full-color organic light emitting diode is manufactured. Conventionally-known colorizing methods of a full-color organic light emitting diode include: a three-color independent deposition method for independently depositing respective red (R), green (G), and blue (B) pixels on a substrate; a color conversion method (CCM) for installing a color conversion layer on a light outputting side by setting blue light emission as a light emission source; and a color filter method for using a color filter by setting white light emission as a light emission source. Of the above-described methods, the three-color independent deposition method has drawn the most attention because it has a simple structure to show excellent color purity and efficiency.

The three-color independent deposition method uses a deposition mask to independently deposit the respective red (R), green (G), and blue (B) colors of the pixels on the substrate, and the deposition mask must be a magnetic substance, as it is closely attached to a substrate on which a material is to be deposited by using a magnet unit, and arrangement of the deposition mask and the substrate requires high precision. Particularly, the width of an opened slit pattern of the deposition mask requires high precision.

However, when the deposition mask is closely attached to the substrate to be deposited, and a magnetic field of the magnet unit is strong, the slit pattern is transformed (e.g., shifted or deformed) by magnetic attraction of the deposition mask. In detail, the magnetic field for attaching the deposition mask is weakened when passing through the deposition mask, a magnetic substance, and in this instance, a magnetic force facing outward from the center by a difference between top and down magnetic fields of the deposition mask, causing the slit patterns to be formed in an external part. The precision of the deposition mask is deteriorated by the transformation of the slit patterns.

The above information disclosed in this Background section is only for enhancement of understanding of the background of the described technology, and may therefore contain information that does not form the prior art that is already known in this country to a person of ordinary skill in the art.

### SUMMARY

Embodiments of the present invention provide a deposition mask for improving precision by reducing or minimizing deviation (e.g., transformation) in a slit pattern caused by a magnetic field.

Embodiments of the present invention have been made to provide a deposition device including the deposition mask.

An exemplary embodiment of the present invention provides a deposition mask including a mask body, a plurality of slits in the mask body, and a plurality of ribs between the slits, wherein the slits include a plurality of deposition slits, and a plurality of dummy slits near the deposition slits.

Widths of respective ones of the dummy slits may be increased as an edge of the mask body is approached.

The widths of the dummy slits may be linearly increased.

The widths of the dummy slits may be exponentially increased.

The mask body may include a magnetic substance.

The widths of the dummy slits may increase in proportion to a magnetic force on respective neighboring ribs from among the plurality of ribs.

The deposition slits may be in parallel with the dummy slits.

The dummy slits may be on both sides of the deposition slits.

The deposition slits and the dummy slits may have substantially equal lengths.

Another embodiment of the present invention provides a deposition device including a deposition mask, a magnet unit facing the deposition mask, a substrate between the magnet unit and the deposition mask, and a deposition source for applying a deposition material on the deposition mask.

According to embodiments of the present invention, the deposition mask reduces or minimizes deviation in a slit pattern by the magnetic field to improve deposition precision.

Further, the deposition device includes the above-noted deposition mask to perform the deposition process in a precise manner.

### BRIEF DESCRIPTION OF THE DRAWINGS

FIG. 1 shows a deposition device using a deposition mask according to an exemplary embodiment of the present invention.

FIG. 2 shows a partial top plan view of a deposition mask of the embodiment shown in FIG. 1.

FIG. 3 shows a partial enlarged view of a deposition mask of the embodiment shown in FIG. 2.

FIG. 4 shows a cross-sectional view of a deposition mask of the embodiment shown in FIG. 3.

FIG. 5 shows a graph illustrating a comparison of an experimental example according to an exemplary embodiment of the present invention and a comparative example.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings are schematic, and might not be proportionally scaled. Relative scales and ratios in the drawings may be enlarged or reduced for the purpose of accuracy and convenience, and the scales may also be random, and not limited thereto. In addition, like reference numerals designate like structures, elements, or parts throughout the specification. It will be understood that when an element is referred to as being “on” another element, it can be directly on another element, or intervening elements may be present therebetween.

Exemplary embodiments represent ideal exemplary embodiments of the present invention in detail. As a result, various modifications of diagrams and the drawings are expected. Accordingly, embodiments of the present invention are not limited to specific shapes of shown regions, and, for example, may also include manufacturing modifications of the shape.

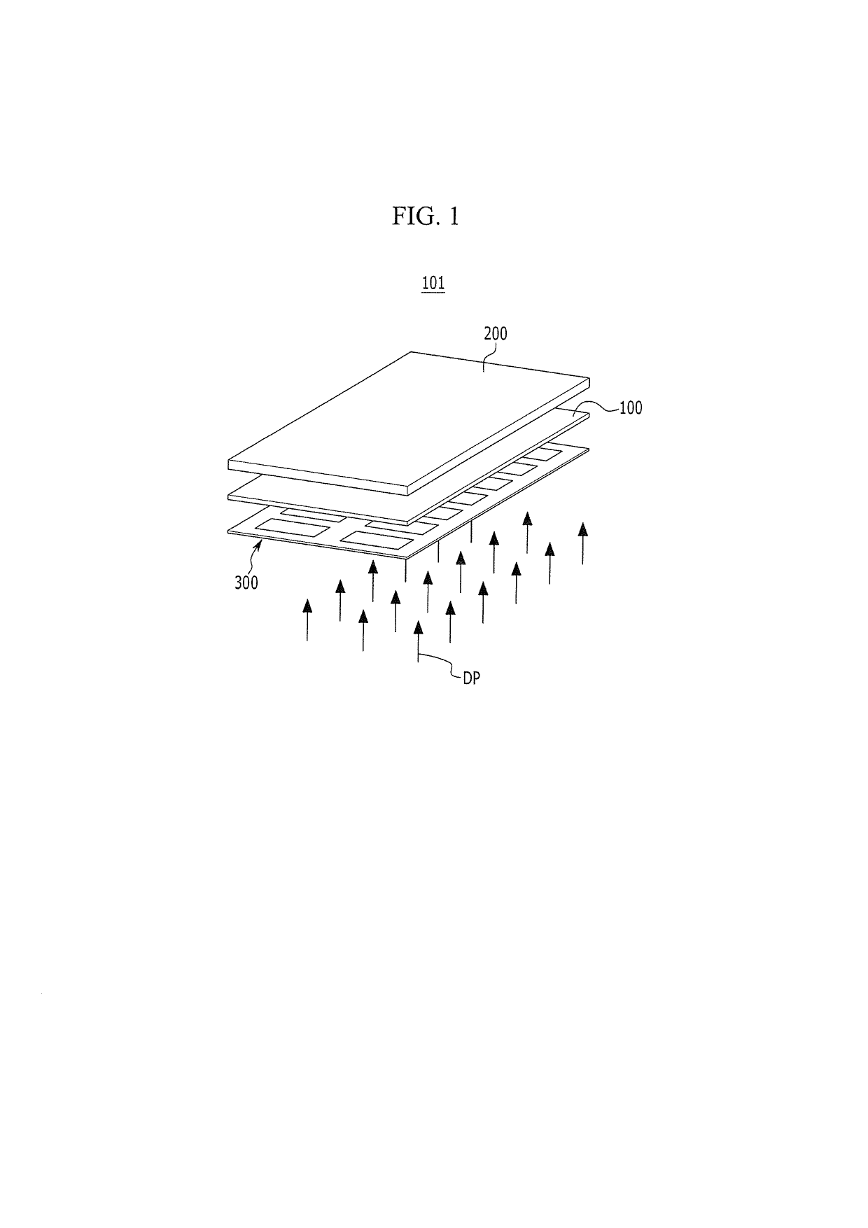

A deposition mask 300 according to an exemplary embodiment of the present invention, and a deposition device 101 using the same, will now be described with reference to FIGS. 1 to 4.

As shown in FIG. 1, the deposition device 101 of the present embodiment includes a deposition mask 300, a magnet unit 200, and a deposition source (DP). A substrate 100 upon which a material is to be deposited is located between the deposition mask 300 and the magnet unit 200.

The deposition mask 300 is fixed to the 100 substrate by the magnet unit 200. Therefore, the deposition mask 300 is made of a magnetic substance that can be affected by the magnetic field of the magnet unit 200, and the deposition mask 300 receives a corresponding magnetic force.

Also, although not shown, the deposition device 101 further includes a chamber for maintaining a vacuous state.

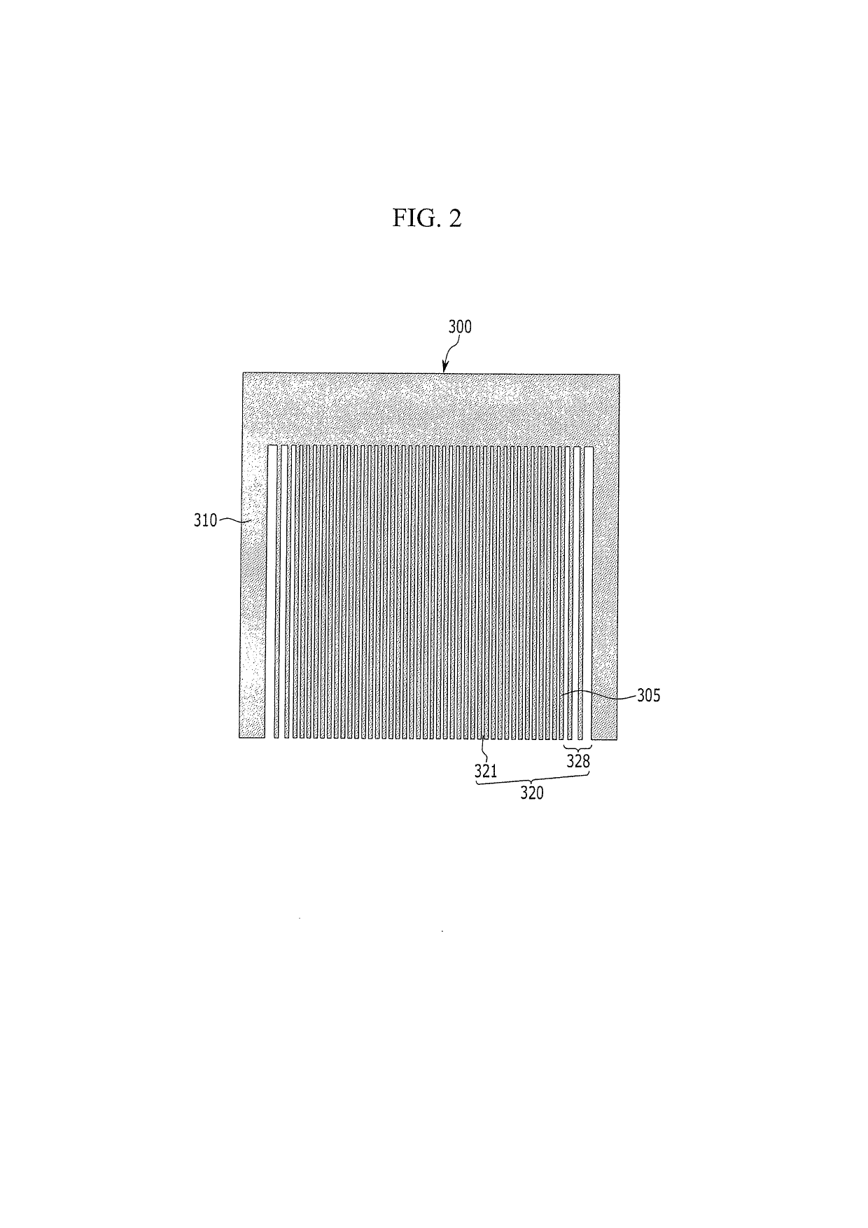

As shown in FIG. 2, the deposition mask 300 of the present embodiment includes a mask body 310, a plurality of slits 320 formed on the mask body 310, and a plurality of ribs 305 formed between the slits 320.

The slits 320 include a plurality of deposition slits 321 having a width (e.g., formed with a predetermined width), and a plurality of dummy slits 328 formed near the deposition slits 321.

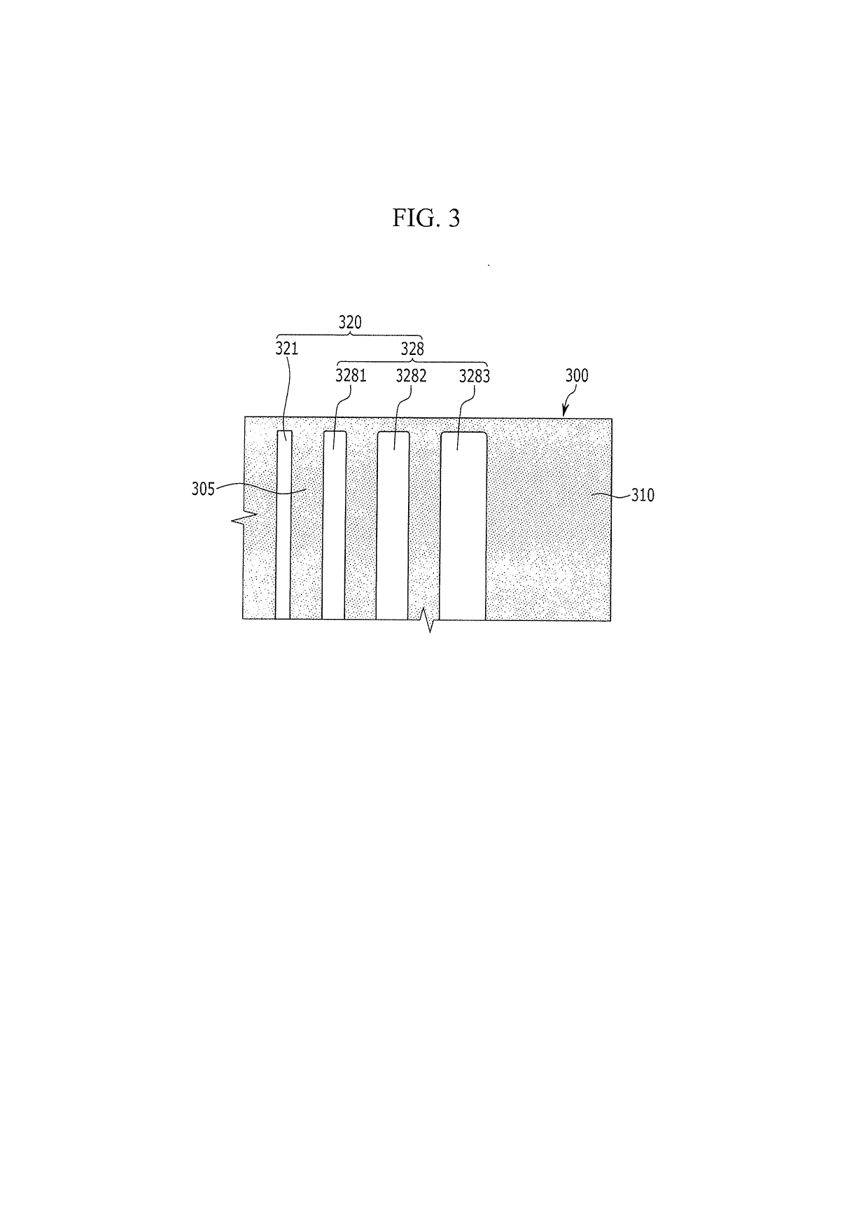

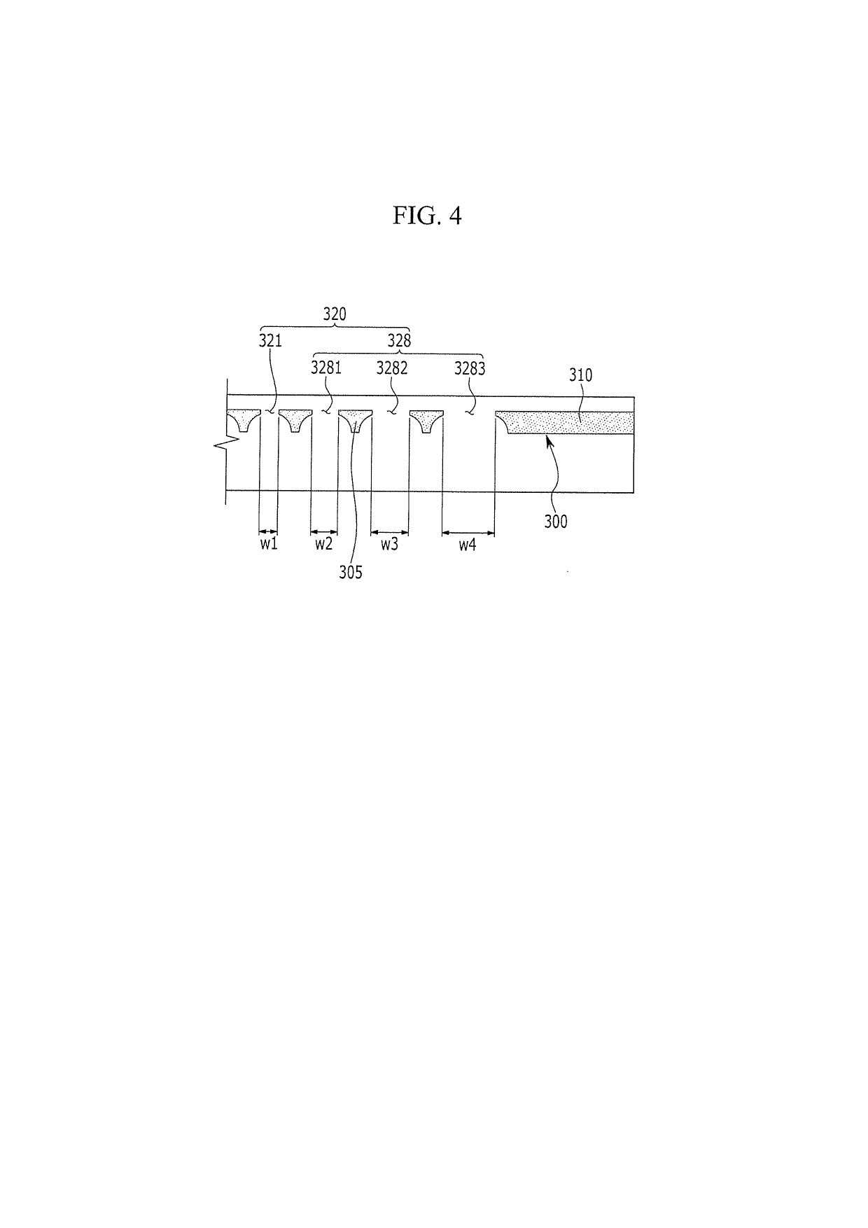

As shown in FIG. 3 and FIG. 4, widths of the dummy slits 321 gradually increase as they approach an edge of the mask body 310 (e.g., the dummy slits 321 closest to the edge of the mask body 310 are widest, and the dummy slits 321 furthest from the edge of the mask body 310 are the most narrow). In detail, the widths of the plurality of dummy slits 328 according to embodiments of the present invention can be increased in a linear functional manner (e.g., increased linearly) toward the edge of the mask body 310.

As shown in FIG. 3 and FIG. 4, as an example, the deposition mask 300 can include three dummy slits 3281, 3282, and 3283. A width w2 of the first dummy slit 3281 may have a size that is approximately 150% of the width w1 of the deposition slits 321, a width w3 of the second dummy slit 3282 may have a size that is approximately 200% of the width w1 of the deposition slits 321, and a width w4 of the third dummy slit 3283 may have a size that is approximately 250% of the width w1 of the deposition slits 321.

However, the present invention is not limited thereto. As a transformed exemplary embodiment of the present invention, widths of a plurality of dummy slits 328 can be exponentially increased when approaching an edge of the mask body 310.

For example, in another embodiment of the present invention, the width w2 of the first dummy slit 3281 can have a size that is approximately 139% of the width w1 of the deposition slits 321, the width w3 of the second dummy slit 3282 can have a size that is approximately 193% of the width w1 of the deposition slits 321, and the width w4 of the third dummy slit 3283 can have the size that is approximately 268% of the width w1 of the deposition slits 321.

Also, as another exemplary embodiment of the present invention, the widths of a plurality of dummy slits 328 can be increased in proportion to the force of the magnetic field on neighboring ribs 305. The force of the magnetic field on the deposition mask 300 is increased when approaching the edge of the mask body 310 (e.g., the magnetic field is stronger at the edge of the mask body 310 than at the center of the mask body 310).

In other embodiments of the present invention, the width w2 of the first dummy slit 3281 can have a size that is approximately 139% of the width w1 of the deposition slits 321, the width w3 of the second dummy slit 3282 can have a size that is approximately 168% of the width w1 of the deposition slits 321, and the width w4 of the third dummy slit 3283 can have a size that is approximately 293% of the width w1 of the deposition slits 321.

According to the above-described configuration, the deposition mask 300 reduces or minimizes deviation in the slit pattern 320 caused by the magnetic field to improve precision (e.g., precision in alignment).

Further, the deposition device 101 can include a deposition mask 300 according to an exemplary embodiment of the present invention to precisely perform the deposition process.

In detail, according to the present exemplary embodiment, the force applied to the rib 305 can be reduced by the magnetic force that is generated when the mask body 310, particularly the rib 305, is magnetically attracted to the magnet unit 200. Therefore, transformation of the slit pattern 320 and the rib 305, particularly transformation of the deposition slits 321, can be reduced or minimized. Accordingly, the deposition mask 300 can maintain high precision in a stable manner.

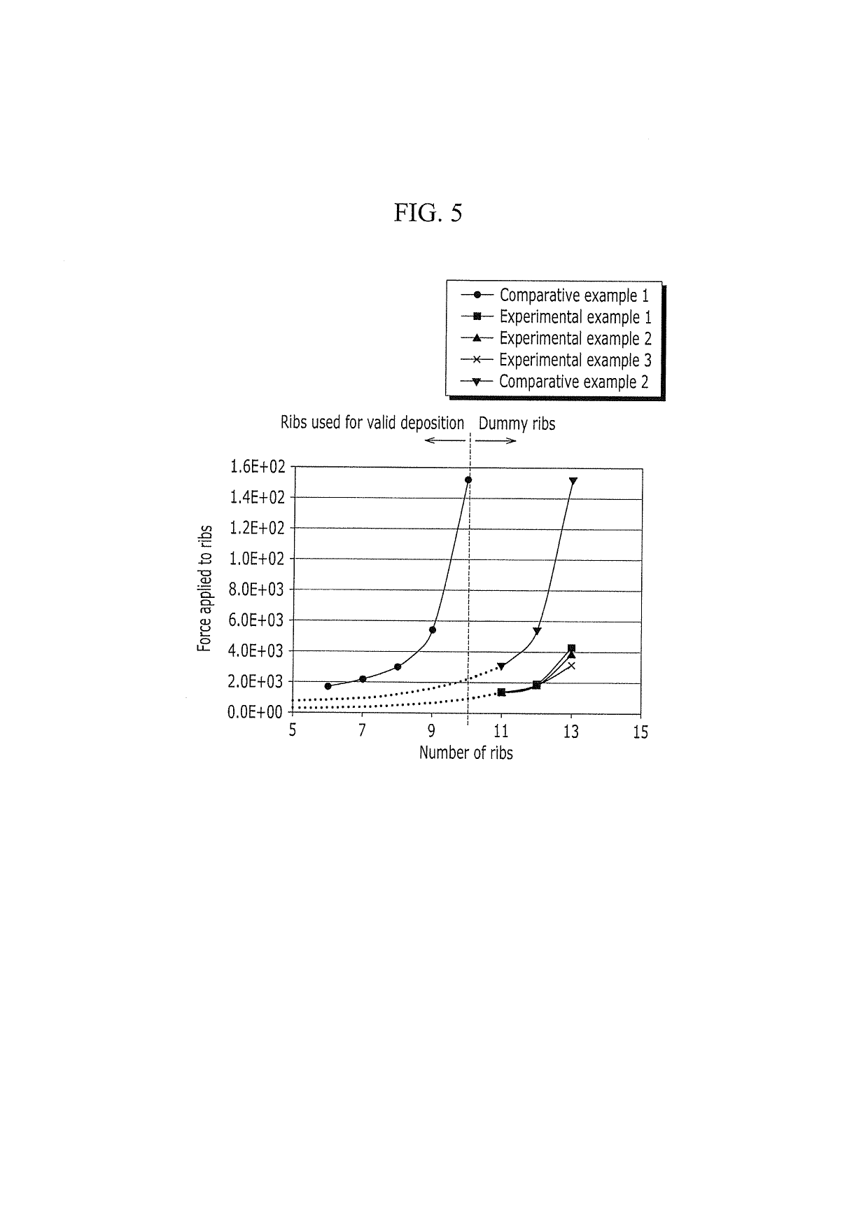

Referring to FIG. 5, experimental examples according to an exemplary embodiment and comparative examples will now be described.

The experimental examples include: Experimental Example 1, in which widths of dummy slits are increased in a linear function manner according to an exemplary embodiment; Experimental Example 2, in which widths of the dummy slits are exponentially increased according to another exemplary embodiment; and Experimental Example 3, in which widths of dummy slits are increased in proportion to the magnetic force according to yet another exemplary embodiment.

The comparative examples include Comparative Example 1, in which no dummy slit is formed, and Comparative Example 2, in which the dummy slit is formed with the same width as the deposition slit.

As shown in FIG. 5, regarding the structure in which the dummy slits 328 are formed, that is, in the case of Experimental Examples 1, 2, and 3 and Comparative Example 2, the force applied to the rib 305 neighboring the deposition slits 321 is substantially reduced.

Also, the width of the dummy slit 328 according to Experimental Examples 1, 2, and 3, in which the widths of the dummy slits 328 are gradually increased when approaching the edge of the mask body 310, are relatively substantially reduced compared to Comparative Example 2, in which the width of the dummy slit 328 is formed to be equivalent to the width of the deposition slits 321.

That is, the deposition mask 300 with a plurality of dummy slits 328 of which the widths are gradually increased when approaching the edge of the mask body 310 can reduce or minimize transformation caused by the magnetic force that is generated when the deposition mask 300 is magnetically attracted to the magnet unit 200.

Therefore, the deposition device 101 using the deposition mask 300 according to the exemplary embodiment has high precision and stably performs the deposition process.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A deposition mask comprising:
a mask body;
a plurality of slits in the mask body; and
a plurality of ribs between the slits,
wherein the slits comprise:
a plurality of deposition slits; and
a plurality of dummy slits near the deposition slits.

2. The deposition mask of claim 1, wherein widths of respective ones of the dummy slits are increased as an edge of the mask body is approached.

3. The deposition mask of claim 2, wherein the widths of the dummy slits are linearly increased.

4. The deposition mask of claim 2, wherein the widths of the dummy slits are exponentially increased.

5. The deposition mask of claim 2, wherein the mask body comprises a magnetic substance.

6. The deposition mask of claim 5, wherein the widths of the dummy slits increase in proportion to a magnetic force on respective neighboring ribs from among the plurality of ribs.

7. The deposition mask of claim 2, wherein the deposition slits are in parallel with the dummy slits.

8. The deposition mask of claim 7, wherein the dummy slits are on both sides of the deposition slits.

9. The deposition mask of claim 8, wherein the deposition slits and the dummy slits have substantially equal lengths.

10. A deposition device comprising:
the deposition mask of claim 1;
a magnet unit facing the deposition mask;
a substrate between the magnet unit and the deposition mask; and
a deposition source for applying a deposition material on the deposition mask.
